(19) United States
(12) Patent Application Publication
(10) Pub. No.: US 2010/0042678 A1
(43) Pub. Date: Feb. 18, 2010

(54) Method and apparatus for providing/receiving user interface using user interface directory

(75) Inventors: Kyung-mo Park, Seoul (KR); Young-sun Ryu, Gyeonggi-do (KR); Hyoung-shick Kim, Gyeonggi-do (KR); Je-young Maeng, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/453,483

(22) Filed: May 12, 2009

(30) Foreign Application Priority Data
Aug. 12, 2008 (KR) 10-2008-0079031

(51) Int. Cl. G06F 15/16; G06F 3/00

(52) U.S. Cl. 709/203; 715/762

(57) ABSTRACT

In a method and apparatus for providing/receiving a user interface (UI), a client requests a first server for a UI that is necessary to access a second server, and the first server having a plurality of UIs provides at least one of the plurality of UIs to the client. Accordingly, the client, which cannot use a UI provided by the second server, can receive the UI from the first server and access the second server.

### CROSS-REFERENCE TO RELATED APPLICATIONS

This application claims the benefit of Korean Patent Application No. 10-2008-0079031, filed on Aug. 12, 2008, in the Korean Intellectual Property Office, the disclosure of which is incorporated herein in its entirety by reference.

### BACKGROUND

1. Field

One or more embodiments of the present invention relate to a method and apparatus for providing/receiving a user interface (UI), and more particularly, to a method and apparatus for providing/receiving a UI that is necessary for a client to access a remote server.

2. Description of the Related Art

A variety of multimedia devices have been developed and convergence has accelerated therebetween. Frequently, different types of multimedia devices constitute a network and communicate multimedia data, or control each other.

Multimedia devices that are physically far apart from each other are remotely controlled via a remote user interface (RUI). A user interface (UI) server provides a UI client with a UI for control. The UI client accesses the UI server via the UI for control. For example, the UI server provides the UI client with a UI for remote control in the form of a web page. The UI client displays the web page through a browser. Thereafter, a client user accesses the UI server through the displayed UI.

### SUMMARY

Additional aspects and/or advantages will be set forth in part in the description which follows and, in part, will be apparent from the description, or may be learned by practice of the invention.

One or more embodiments include a method and apparatus for providing/receiving a user interface (UI) that is necessary for a client to access a remote server, and a computer-readable recording medium having embodied thereon a program for executing the method.

Additional aspects and/or advantages will be set forth in part in the description which follows and, in part, will be apparent from the description, or may be learned by practice of the invention.

To achieve the above and/or other aspects and advantages, one or more embodiments of the present invention may include a method of providing a client with a UI, wherein the providing is performed by a first server, the method comprising: receiving from the client a message requesting a UI that is necessary to access a second server; and providing the client with at least one of a plurality of UIs of the first server.

The receiving may comprise receiving information about a capability of the client from the client. The plurality of UIs may comprise a plurality of UI templates.

The providing may comprise: selecting at least one of the plurality of UI templates on the basis of the information about the capability of the client; receiving information about the second server from the client; generating the requested UI on the basis of the selected UI templet and the information about the second server; and transmitting the generated UI to the client.

The providing may comprise: selecting at least one of the plurality of UI templates on the basis of the information about the capability of the client; and transmitting the selected UI templet to the client, wherein the client generates the UI, which is necessary to access the second server, on the basis of the selected UI template and the information about the second server.

One or more embodiments include a method of receiving a UI from a first server, wherein the receiving is performed by a client, the method comprising: requesting the first server for a UI that is necessary to access a second server; and receiving the first server for at least one of a plurality of UIs, which may belong to the first server, in response to the request.

One or more embodiments of the present invention may include an apparatus for providing a client with a UI, wherein the providing is performed by a first server, the apparatus comprising: a connecting unit to receive from the client a message requesting a UI that is necessary to access a second server; and a UI managing unit to provide the client with at least one of a plurality of UIs of the first server.

One or more embodiments include an apparatus for receiving a UI from a first server, wherein the receiving is performed by a client, the apparatus including: a connecting unit to request the first server for a UI that is necessary for the client to access a second server; and a UI managing unit to receive at least one of a plurality of UIs from the first server in response to the request.

One or more embodiments of the present invention include a computer-readable recording medium having embodied thereon a program for executing the method.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a data flow diagram illustrating a method of providing/receiving a user interface (UI), according to an embodiment;

FIG. 2A illustrates a description for the presentation of a UI, according to an embodiment;

FIG. 2B illustrates a description for the function of the UI of FIG. 2A, according to an embodiment;

FIG. 3A illustrates a description for the presentation of a UI, according to another embodiment;

FIG. 3B illustrates a description for the function of the UI of FIG. 3B, according to another embodiment;

FIGS. 4A and 4B illustrate UI fragments according to an embodiment;

FIG. 5 is a data flow diagram illustrating a method of providing/receiving a UI, according to another embodiment;

FIG. 6A is a block diagram of a first server for providing a UI, according to an embodiment;

FIG. 6B is a block diagram of a UI managing unit of the first server of FIG. 6A; and

FIG. 7 is a block diagram of a client for receiving a UI, according to an embodiment.

### DETAILED DESCRIPTION OF EMBODIMENTS

Reference will now be made in detail to embodiments, examples of which are illustrated in the accompanying drawings, wherein like reference numerals refer to the like elements throughout. In this regard, the present invention may be embodied in many different forms and should not be construed as being limited to the embodiments set forth herein. Accordingly, embodiments are merely described below, by referring to the figures, in order to explain aspects of the present invention.

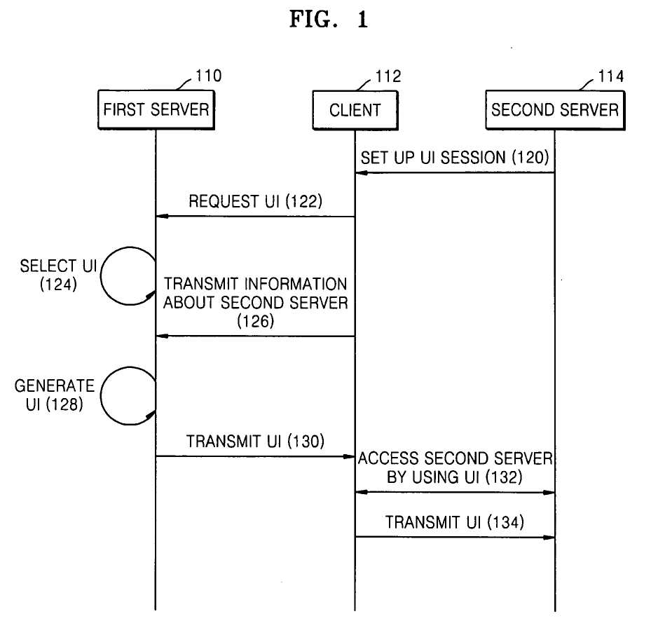

FIG. 1 is a data flow diagram illustrating a method of providing/receiving a user interface (UI), according to an embodiment. In FIG. 1, a first server 110 provides a UI that is necessary for a client 112 to access a second server 114.

Referring to FIG. 1, in operation 120, the client 112 and the second server 114 sets up a UI session. The client 112 discovers a UI that is necessary to access the second server 114, and determines whether the UI is matched to a capability of the client 112.

The second server 114 may not provide the UI, if the second server 114 does not serve as a UI server or a standard for the UI does not match the client 112.

Even though the second server provides the UI, the client 112 may not be able to display the UI because of the capability of the client 112, for example, if the UI for audio/video (AV) control provided by the second server 114 supports only resolutions of 320×240 and 1920×1080 pixels whereas the client 112 supports only a resolution of 1920×1200 pixels. That is, the client 112 may not be able to display the UI if the client 112 is a new product and is not compatible with the second server 114.

Although a display resolution has been described as an example of the capability of the client 112, examples of the capability of the client 112 include a screen ratio and a color depth, and the client 112 may not be able to display the UI if the screen ratio or the color depth of the client 112 is not compatible with the UI provided by the second server 114.

In operation 122, the client 112 requests the first server 110 for the UI that is necessary to access the second server 114. The first server 110 may be a server operated by a manufacturer of the client 112 which provides a UI-related service so that the client 112 can display UIs of various servers.

At the same time when the client 112 requests the first server 110 for the UI, information about the capability of the client 112 may be transmitted to the first server 110. Since the client 112 cannot display the UI provided by the second server 114 because of the capability of the client 112 and thus requests the first server 110 for the UI, the information about the capability of the client 112 should be transmitted to the first server 110 so that the UI matched to the capability of the client 112 can be provided to the client 112.

For example, if the client 112 cannot display the UI because the UI provided by the second server 114 supports only resolutions of 320×240 and 1920×1080 pixels and the client 112 supports only a resolution of 1920×1200 pixels, information about the resolution of 1920×1200 pixels of the client 112 is also transmitted to the first server 110 when the client 112 requests the first server 110 for the UI.

In addition to the information about the capability of the client 112, information about an application of the second server 114 which the client 112 tries to access may also be transmitted when the client 112 requests the first server 110 for the UI. For example, if the client 112 tries to access an AV stream-related application of the second server 114, the client 112 should receive a UI for AV stream control from the first server 110. Accordingly, the information about the application of the second server 114 which the client 112 tries to access may be transmitted to the first server 110 along with the information about the capability of the client 112 in operation 122.

In operations 124 through 130, the first server 110 provides at least one UI among a plurality of UIs, which may belong to the first server 110, to the client 112 in response to the request in operation 122.

Referring again to FIG. 1, in operation 124, the first server 110 selects at least one UI in accordance with the request of the client 112 from among the plurality of UIs which may belong to the first server 110. In FIG. 1, the first server 110 selects at least one UI templet in accordance with the request of the client 112 from among a plurality of UI template which may belong to the first server 110.

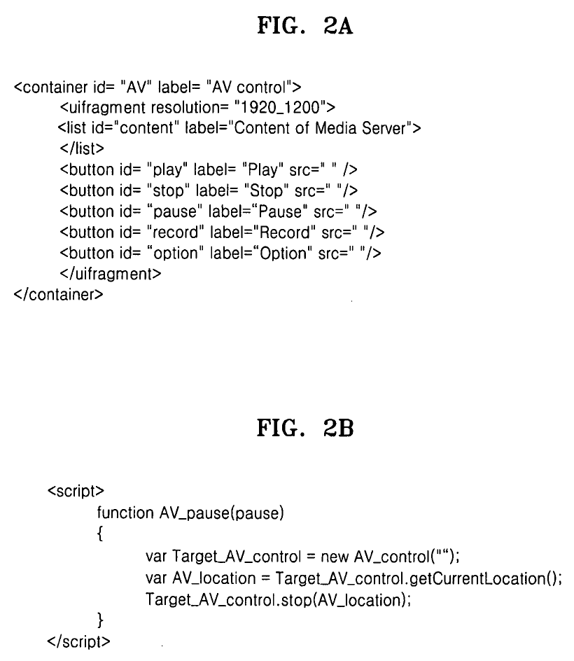

FIGS. 2A and 2B illustrate a UI, that is, a UI templet, according to an embodiment.

The UI templet in FIGS. 2A and 2B includes a description for the presentation of a UI and a description for the function of the UI as information about a framework of the UI.

The description for the presentation of the UI includes information necessary for the presentation of the UI, for example, information about elements constituting the UI, such as buttons, menus, and widgets, and information about a layout. The description for the function of the UI includes information about a method of interaction between a user and an application of the second server 114 which is controlled through the UI, in other words, information about the function controlled through the UI.

FIG. 2A illustrates a description for the presentation of a UI, according to an embodiment.

Referring to FIG. 2A, a UI template “AV control” of the first server 110 supports a resolution of 1920×1200 pixels, and displays buttons “Play”, “Stop”, “Pause”, “Record”, and “Option”.

FIG. 2B illustrates a description for the function of the UI of FIG. 2A, according to an embodiment.

The description of FIG. 2B is for a function “Pause”. The description for the function of the UI of FIG. 2B does not include information about the second server 114 which the client 112 accesses using the function “Pause”.

Referring to FIG. 1 again, in operation 124, the first server 110 selects at least one UI template that matches the resolution supported by the client 112 among the plurality of UI templates. The UI templet may be information that does not include information about an address of a button image and/or an address of the second server 114 as shown in FIGS. 2A and 2B.

In operation 126, the client 112 transmits information about the second server 114 to the first server 110. The first server 110 generates a UI based on the information about the second server 114.

The information about the second server 114 may include information about a uniform resource locator (URL), a port, and/or a state variable, which are necessary for the client 112 to access the second server 114. For example, the information about the second server 114 includes a URL of an application of the second server 114, which the client 112 tries to access using the UI, and a port used for the access. Also, the information about the second server 114 may include a state variable that is transmitted to the second server 114 according to the UI and the user when the client 112 accesses the second server 114 by using the UI.

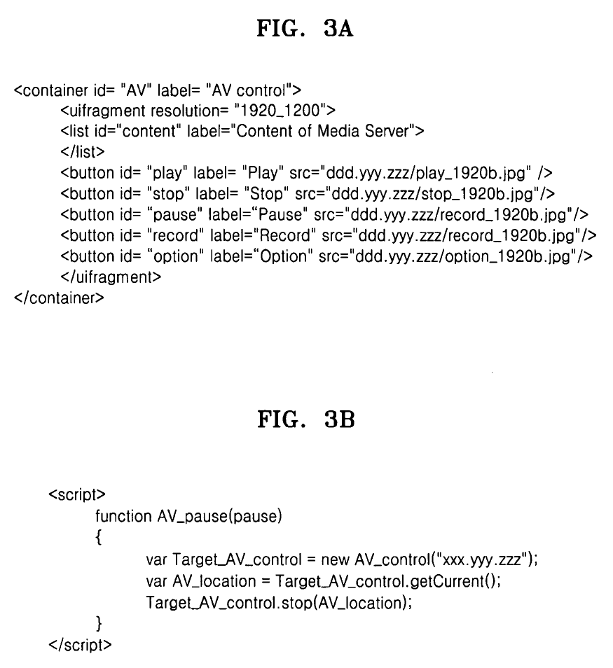

In operation 128, the first server 110 generates the UI based on the at least one UI templet selected in operation 124 and the information about the second server 114 received in operation 126 by inputting a real address of the first server 110 or the second server 114 to the UI templet which will now be explained with reference to FIGS. 3A and 3B in detail.

FIGS. 3A and 3B illustrate a UI according to another embodiment.

FIG. 3A illustrates a description for the presentation of a UI, according to another embodiment. The first server 110 generates a UI for AV control supporting a resolution of 1920×1200 pixels by using at least one UI templet among a plurality of UI templets which belong to the first server 110. FIG. 3A illustrates a description for the presentation of the UI supporting the resolution of 1920×1200 pixels.

When comparing FIGS. 3A and 2A, the description of FIG. 3A includes information about button images of buttons included in a UI supporting a resolution of 1920×1080 pixels. The at least one UI templet selected in operation 124 already defines buttons included in the UI supporting the resolution of 1920×1200 pixels. The first server 110 generates the UI by inputting an address of each of the button images to the UI templet in operation 128. Each of the button images of the buttons included in the UI of FIG. 3A may be obtained from an address “ddd.yyy.zzz”, and the address “ddd.yyy.zzz” may be an address of the first server 110 for example.

If the address, which may be used to obtain each of the images of the buttons, is invariably the same as the address of the first server 110, address information does not need to be additionally input to the UI template. In this case, the first server 110 may generate the UI by modifying only a description for the function of the UI.

FIG. 3B illustrates a description for the function of the UI of FIG. 3A, according to another embodiment.

In FIG. 3B, a function “Pause” is exemplarily explained. The UI templet already defines the function “Pause” of the UI supporting the resolution of 1920×1200 pixels. The first server 110 may generate the UI by inputting the address of the second server 114 to the description for the function in operation 128. In FIG. 3B, the function “Pause” is a function for the AV control of the second server 114 having the address “xxx.yyy.zzz”.

Referring to FIG. 1 again, in operation 130, the first server 110 transmits the UI, which is generated based on a predetermined UI template in operation 128, to the client 112. The description for the presentation of the UI and the description for the function of the UI are transmitted to the client 112.

In operation 132, the client 112 accesses the second server 114 by using the UI received in operation 130. The client 112 displays the received UI, and accesses the second server 114 on the basis of an interaction between the displayed UI and a user.

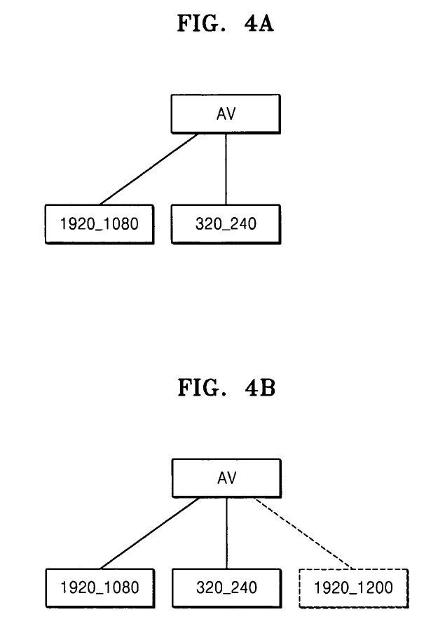

In operation 134, which is optional, the client 112 transmits the UI received in operation 130 to the second server 114. Since the newly generated UI is transmitted to the second server 114, the UI of the second server 114 may be provided to clients having other various capabilities which will now be explained with reference to FIGS. 4A and 4B.

FIGS. 4A and 4B illustrate UI fragments according to an embodiment.

FIG. 4A illustrates UI fragments which originally belong to the second server 114. The second server 114 has only UIs supporting resolutions of 1920×1080 and 320×240 pixels.

However, since the second server 114 receives the newly generated UI in operation 134, the second server 114 also has the UI supporting the resolution of 1920×1200 pixels.

According to the aforesaid method of FIG. 1, the client 112 can access the second server 114 by dynamically receiving the UI from the first server 110 even if the second server 114 does not provide the UI or the UI provided by the second server 114 is not compatible with the client 112.

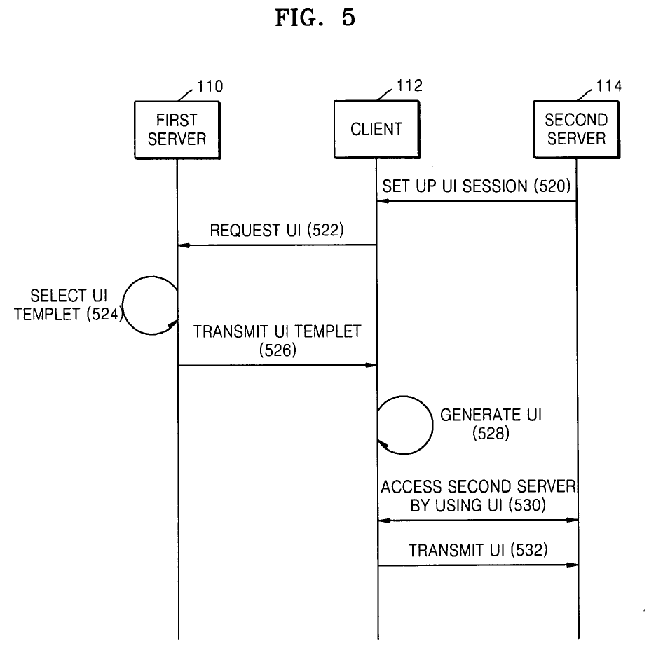

FIG. 5 is a data flow diagram illustrating a method of providing/receiving a UI, according to another embodiment.

Referring to FIG. 5, in operation 520, the client 112 and the second server 114 set up a UI session. The client 112 discovers a UI that is necessary to access the second server 114, and determines whether the UI is matched to a capability of the client 112. Operation 520 corresponds to operation 120 of FIG. 1.

In operation 522, the client 112 requests the first server 110 for the UI that is necessary to access the second server 114. Operation 522 corresponds to operation 122 of FIG. 1.

At the same time when the client 112 requests the first server 110 for the UI, information about the capability of the client 112 may be transmitted. In addition to the information about the capability of the client 112, information about an application of the second server 114 which the client 112 tries to access may also be transmitted when the client 112 requests the first server 110 for the UI.

In operation 524, the first server 110 selects at least one UI in accordance with the request of the client 112 from among a plurality of UIs which may belong to the first server 110. In FIG. 5, the first server 110 selects at least one UI templet in accordance with the request of the client 112 from among a plurality of UI templets which may belong to the first server 110. Operation 524 corresponds to operation 124.

In operation 526, the first server 110 transmits the UI template selected in operation 524 to the client 112. In the method of FIG. 5, the client 112 directly generates the UI unlike in the method of FIG. 1. Accordingly, the first server 110 acts only as a UI directory that transmits one of the plurality of UI templets, which may belong to the first server 110, to the client 112.

In operation 528, the client 112 generates the new UI based on the UI templet received in operation 526 and information about the second server 114. A process of generating the UI has already been described in detail with reference to FIGS. 3A and 3B. Except that in the method of FIG. 5, the client 112, not the first server 110, generates the UI, the process of generating the UI is the same as in the method of FIGS. 3A and 3B.

In operation 530, the client 112 accesses the second server 114 by using the UI generated in operation 528. The client 112 displays the UI, and accesses the second server 114 on the basis of an interaction between the displayed UI and the user.

In operation 532, the client 112 transmits the generated UI to the second server 114. Operation 532 corresponds to operation 134 of FIG. 1. Since the generated UI is transmitted to the second server 114, the UI of the second server 114 may be provided to clients having other various capabilities

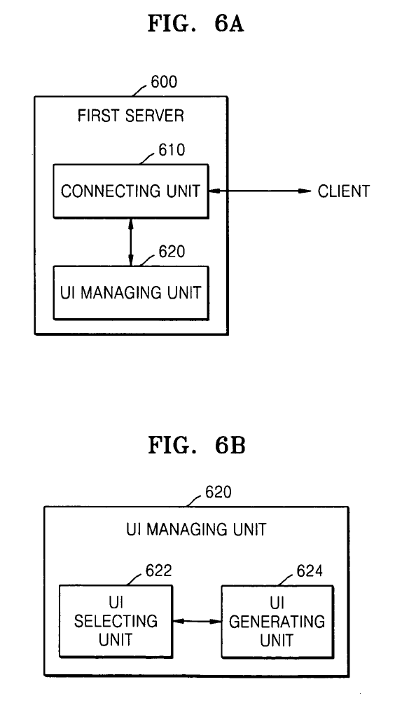

FIG. 6A is a block diagram of a first server 600 for providing a UI, according to an embodiment.

Referring to FIG. 6A, the first server 600 includes a connecting unit 610 and a UI managing unit 620.

The connecting unit 610 receives from a client a message requesting a UI, and provides the UI, which is generated by the UI managing unit 620, to the client in response to the request.

When receiving the message requesting the client for the UI, the connecting unit 610 also receives information about a capability of the client and transmits the received information about the capability of the client to the UI managing unit 620. Also, the connecting unit 610 receives from the client information about a second server which the client tries to access and transmits the received information about the second server to the UI managing unit 620.

The UI managing unit 620 searches a database of a plurality of UIs which may belong to the UI managing unit 620, and selects at least one UI that is requested by the client. In FIG. 6A, the UI managing unit 620 selects at least one UI templet matched to the UI requested by the client by referring to a plurality of UI templets which may belong to the UI managing unit 620.

The selected UI templet may be transmitted through the connecting unit 610 to the client such that the client may directly generate the UI based on the UI templet. Alternatively, the first server 600 may generate the UI and provide the generated UI to the client which will now be explained in detail with reference to FIG. 6B.

FIG. 6B is a block diagram of the UI managing unit 620 of the first server 600 of FIG. 6A.

Referring to FIG. 6B, the UI managing unit 620 includes a UI selecting unit 622 and a UI generating unit 624. The UI selecting unit 622 selects at least one UI templet from among the plurality of UI templets according to the message requesting the client for the UI which is received through the connecting unit 610. The UI selecting unit 622 selects the one UI templet on the basis of the information about the capability of the client, which is received through the connecting unit 610.

The UI generating unit 624 generates the UI based on the UI templet selected by the UI selecting unit 622 and the information about the second server, which is received from the client through the connecting unit 610. A process of generating the UI has already been explained with reference to FIGS. 3A and 3B. The generated UI is transmitted to the client through the connecting unit 610. If only the UI templet is transmitted to the client and the client directly generates the UI, the UI generating unit 624 becomes an element of the client, not an element of the first server 600.

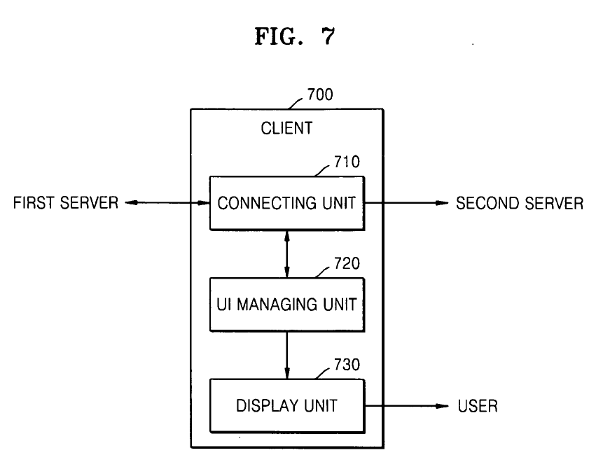

FIG. 7 is a block diagram of a client 700 for receiving a UI, according to an embodiment.

Referring to FIG. 7, the client 700 includes a connecting unit 710, a UI managing unit 720, and a display unit 730.

The connecting unit 710 transmits and receives data for a UI. The connecting unit 710 transmits a message requesting a UI to a first server. The connecting unit 710 may transmit information about an application of a second server, which the client 700 tries to access, and/or information about a capability of the client 700 to the first server. The connecting unit 710 also transmits information about the second server to the first server, such that the first server generates the UI based on the information about the second server.

The connecting unit 710 receives the UI, which is necessary to access the second server, provided by the first server according to the message requesting the UI. The connecting unit 710 may transmit the received UI to the second server. If the connecting unit 710 receives only a UI templet from the first server, the connecting unit 710 may transmit the received UI templet to the UI managing unit 720 so that the UI is generated based on the UI templet.

The UI managing unit 720 stores the UI received from the connecting unit 710 and transmits the stored UI to the display unit 730. The display unit 730 displays the received UI. If the UI managing unit 720 receives only the UI templet from the connecting unit 710, the UI managing unit 720 generates the UI based on the received UI templet and the information about the second server, and transmits the generated UI to the display unit 730. The generated UI may be transmitted through the connecting unit 710 to the second server.

The display unit 730 receives the UI from the UI managing unit 720 and displays the received UI.

While aspects of embodiments have been particularly shown and described with reference to differing embodiments thereof, it should be understood that these exemplary embodiments should be considered in a descriptive sense only and not for purposes of limitation. Descriptions of features or aspects within each embodiment should typically be considered as available for other similar features or aspects in the remaining embodiments. Thus, although a few embodiments have been shown and described, it would be appreciated by those of ordinary skill in the art that changes may be made in these embodiments without departing from the principles and spirit of the invention, the scope of which is defined in the claims and their equivalents.

One or more embodiments may be implemented through computer-readable codes on a computer-readable recording medium. The computer-readable recording medium is any data storage device that can store data which can be thereafter read by a computer system. Examples of the computer-readable recording medium include read-only memories (ROMs), random-access memories (RAMs), CD-ROMs, magnetic tapes, floppy disks, and optical data storage devices. The computer-readable recording medium can also be distributed over network coupled computer systems so that the compute readable code is stored and executed in a distributed fashion.

What is claimed is:

1. A method of providing a client with a user interface (UI), wherein the providing is performed by a first server, the method comprising:
receiving from the client a message requesting a UI that is necessary to access a second server; and
providing the client with at least one of a plurality of UIs of the first server.

2. The method of claim 1, wherein the receiving comprises receiving information about a capability of the client from the client.

3. The method of claim 2, wherein the plurality of UIs comprise a plurality of UI templets.

4. The method of claim 3, wherein the providing comprises:
selecting at least one of the plurality of UI templets on the basis of the information about the capability of the client;
receiving information about the second server from the client;
generating the requested UI on the basis of the selected UI templet and the information about the second server; and
transmitting the generated UI to the client.

5. The method of claim 4, wherein the information about the second server comprises at least one of a uniform resource locator (URL), a port, and a state variable which are necessary to access the second server.

6. The method of claim 3, wherein the providing comprises:
selecting at least one of the plurality of UI templets on the basis of the information about the capability of the client; and
transmitting the selected UI templet to the client,
wherein the client generates the UI, which is necessary to access the second server, on the basis of the selected UI templet and the information about the second server.

7. A method of receiving a User Interface(UI) from a first server, wherein the receiving is performed by a client, the method comprising:
requesting the first server for a UI that is necessary to access a second server; and
receiving at least one of a plurality of UIs from the first server, in response to the request.

8. The method of claim 7, wherein the requesting comprises transmitting information about a capability of the client to the first server.

9. The method of claim 8, wherein the plurality of UIs comprise a plurality of UI templets.

10. The method of claim 9, wherein the receiving comprises:
transmitting information about the second server to the first server; and
receiving from the first server the UI that is generated by the first server on the basis of the information about the second server and a predetermined UI templet,
wherein the predetermined UI templet is at least one UI templet selected from among the plurality of UI templets on the basis of the information about the capability of the client.

11. The method of claim 10, wherein the information about the second server comprises at least one of a URL, a port, and a state variable, which are necessary to access the second server.

12. The method of claim 9, wherein the receiving comprises:
receiving at least one UI templet selected from among the plurality of UI templets on the basis of the information about the capability of the client; and
generating the UI, which is necessary to access the second server, on the basis of the received UI templet and the information about the second server.

13. The method of claim 7, further comprising transmitting the UI, which is received from the first server, to the second server.

14. An apparatus for providing a client with a UI, wherein the providing is performed by a first server, the apparatus comprising:
a connecting unit to receive from the client a message requesting a UI that is necessary to access a second server; and
a UI managing unit to provide the client with at least one of a plurality of UIs of the first server.

15. The apparatus of claim 14, wherein the UI managing unit comprises:
a UI selecting unit to select at least one of a plurality of UI templets on the basis of information about a capability of the client; and
a UI generating unit to generate the requested UI on the basis of the selected UI templet and information about the second server, which is received from the client,
wherein the connecting unit transmits the generated UI to the client.

16. The apparatus of claim 14, wherein the UI managing unit selects at least one of a plurality of UI templets on the basis of information about a capability of the client, wherein the connecting unit transmits the selected UI templet to the client.

17. An apparatus for receiving a User Interface (UI) from a first server, wherein the receiving is performed by a client, the apparatus comprising:
a connecting unit to request the first server for a UI that is necessary for the client to access a second server; and
a UI managing unit to receive at least one of a plurality of UIs from the first server in response to the request.

18. The apparatus of claim 17, wherein the connecting unit transmits information about the second server to the first server,
wherein the UI managing unit receives from the first server the UI that is generated by the first server on the basis of the information about the second server and a predetermined UI templet,
wherein the predetermined UI templet is at least one UI templet selected from among a plurality of UI templets on the basis of information about the capability of the client.

19. The apparatus of claim 17, wherein the connecting unit receives at least one UI templet selected from among a plurality of UI templets on the basis of information about a capability of the client,
wherein the UI managing unit generates the UI, which is necessary to access the second server, on the basis of the received UI templet and information about the second server.

20. The apparatus of claim 17, wherein the connecting unit transmits the UI, which is received from the first server, to the second server.

21. A computer-readable recording medium having embodied thereon a program for executing the method of claim 1.

22. A computer-readable recording medium having embodied thereon a program for executing the method of claim 7.
